(19) United States
(12) Patent Application Publication
(10) Pub. No.: US 2011/0096084 A1
(43) Pub. Date: Apr. 28, 2011

(54) LIQUID CRYSTAL DISPLAY WITH FUNCTION OF STATIC COLOR COMPENSATION AND METHOD THEREOF

(76) Inventors: Kai-Ting HU, Taichung City (TW); Wen-Chih Tai, Zhubei City (TW); Shian-Jun Chiou, Taipei City (TW); Chi-Chung Tsai, Jinhu Township (TW); Chia-Lin Liu, Daya Township (TW); Chi-Neng Mo, Zhongi City (TW)

(21) Appl. No.: 12/770,085

(22) Filed: Apr. 29, 2010

(30) Foreign Application Priority Data
Oct. 23, 2009 (TW) 098135984

(51) Int. Cl. G09G 3/36; G09G 5/00; G09G 5/02

(52) U.S. Cl. 345/589; 345/88; 345/207

(57) ABSTRACT

The present invention discloses a liquid crystal display with function of static color compensation and method thereof, the purpose of the present invention is achieved by utilizing LC Off technique and light sensing technique. The liquid crystal display comprises: a liquid crystal plate; a backlight, disposed on at least one side of the liquid crystal plate; at least one light sensor, disposed adjacent to the liquid crystal plate, and the light sensor has a sensing plane which faces to the backlight; and a timing controller, which receives brightness value measured from the light sensor when LC Off and computes the data to monitor the brightness and chromaticity of the backlight.

### FIELD

The present invention is generally related to a liquid crystal display with function of color detection and compensation. More particularly, the present invention is directed towards a liquid crystal display which detects the static color compensation of ambient light and back light by utilizing black frame technology.

### BACKGROUND

The flat panel display (FPD) is the leading trend of display devices and liquid crystal display (LCD) is the dominating flat panel technology. A liquid crystal display (LCD) has advantages of small size, thin thickness, low weight, low radiation, low power consumption, high resolution and high brightness, and is the most widely applied flat panel display in personal computer, electric board and home theater. LCD may include a panel formed by plural LCD cells and pixel elements with each associating with a corresponding liquid crystal cell. These pixel elements are substantially arranged in the form of a matrix having a number of pixel rows and a number of pixel columns. A plurality of gate signals and data signal are sequentially applied to the number of pixel rows for controlling the status of liquid crystal and controlling the light output of each pixel on the liquid crystal panel. In general, the methods for additive mixture of color stimuli in liquid crystal display technology can be divided into two groups. One is space color-blending method, such as Color Filter technique, which forms color mixing in a space due to each pixel is consists of 3 sub-pixels, the RGB's. As 3 RGB sub-pixels is smaller than the unaided eye can see, additive mixture of color stimuli can be realized by controlling brightness of 3 RGB sub-pixels. In addition, because the color filter includes red filter units, green filter units, and blue filter units, as a backlight illuminates, the desired light (i.e. red, green or blue light) can be obtained by controlling brightness of 3 RGB sub-pixels and additive mixture of color stimuli can be realized. The other one is sequential color mixing, such as Color Sequential, which realizes color mixture in temporal domain. It is commonly applied in Color Sequential Display (CSD), also named Field Sequential Display, Color Filter-less Display. The principle of Color Sequential display is using three primary colors of each pixel displayed sequentially to synthesize a color image or frame in human visible persistence duration. In other words, the intensity of three primary colors is respectively and sequentially displayed in three time segments or Sub-frame and displayed in one pixel. By rapidly alternating primary colors sequentially in time, due to the vision persistence effect, primary colors cannot be identified by the human eye as the alternating time is shorter than duration of visible persistence and human eye blends those pixels into complete pictures (color mixture).

For example, in a 60 Hz display, the three primary colors are alternated in 1/180 seconds, and respectively and sequentially displayed in three time segments or Sub-frame, and displayed in one pixel. Due to the vision persistence effect, it is result in three different intensities of primary colors overlap in 1/60 seconds and color images are presented.

Furthermore, Color Sequential technique is more advanced than the traditional color filter technique. The advantage of Color Sequential technique is as follow:

1. More high-resolution: Displays adopting color sequential technique have high resolution due to no color resisters for increasing the space resolution of the panel. Due to no light consumption resulting from the color resisters, the color sequential technique increases the transmittance of the panel pixels and the transmittance rates of the color sequential display are increased about three times.

2. Lower cost : The manufacturing cost of color sequential display is effectively lowered. Color sequential display has no color filters, so the structure can be simplified, and the coating and treating procedures of the color filters can be omitted. In addition, the working-hour can be reduced and the yield can be increased.

3. The number of driving integrated circuits of the color sequential display can be reduced. The driving integrated circuits output voltage to make the liquid crystal molecule orientations changed so as to control the transmittance of each pixel to form the display image. Moreover, the color sequential technique can decrease the number of thin film transistors in a single pixel so that the complexity of the control circuit can be simplified and the space resolution of the panel pixel can be improved.

4. The color equilibrium can be adjusted better. Each independent light source can be adjusted to achieve a better uniformity of color displaying of the panel adopting an independent light source

However, in order to color compensate each independent light source, lower power consumption and reduce eye strain and fatigue, current liquid crystal display devices may utilize the Ambient Light Sensor to detect the intensity of ambient light, and then, adjust the brightness of backlight source according to the result of detection, perform color compensation to instantaneously adjust image quality of liquid crystal panel. For the purpose of detecting ambient light efficiently, the sensing face of Ambient Light Sensor should be disposed outwardly.

U.S. patent application Ser. No. 12/096,929 discloses a display device with ambient light sensing. It is directed to a method for detecting ambient light; refer to FIG. 1, which consists of turning off the backlight source in step 50, making a measurement of the characteristics of the ambient illumination in step 52, turning on the backlight source in step 54, detecting brightness in step 56 and performing computation in step 58. The method is utilizing the ambient light sensor to detect the brightness as the backlight source turning on and off, and processing the detected brightness, and controlling the brightness of the backlight source accordingly. Additionally, in color detection and compensation of liquid crystal display, it is usually by mean of dynamic color compensation, that is to say, the display performs real-time comparing and computing, and controlling the brightness of the backlight source to perform the color compensation.

However, there are many disadvantages to applying dynamic color compensation to the color sequential display, especially displaying a non-uniform image in the display. Please refer to FIG. 2, take a liquid crystal display of notebook computer 60 as an example, when displaying two images having very different image contrast in the liquid crystal display, the brightness detected by the light sensor is not the average brightness level of backlight source form liquid crystal panel. In this situation, it would be result in inaccuracy of color compensation due to the imprecise detection. In addition, because there is no color filter in color sequential liquid crystal display, the transmittance of the panel is high, and ambient light is easily transmitted through the liquid crystal panel and detected by ambient light sensor. Consequently, as the detecting the brightness of the backlight source and performing dynamic color detection and compensation, ambient light sensor is easily influenced by ambient light and detecting the brightness of the backlight source inaccurately, and it resulted in color compensation which falls short of expectations. Therefore, a liquid crystal display and a method for efficiently detecting ambient light and the brightness of backlight source, increasing the detected brightness and chromaticity of backlight source, reducing the influence of ambient light, enabling more accurate color compensation, and promoting the quality of liquid crystal panel are necessary.

### SUMMARY

One purpose of the present invention is providing a method for effectively detecting the brightness of backlight source and ambient light, performing color compensation to correctly adjust the backlight source, and increasing the brightness and the color accuracy of liquid crystal display.

Another purpose of the present invention is utilizing light sensing technique and black frame technique, i.e. Liquid Crystal Off technique (hereinafter simply referred to as “LC Off”), and Liquid Crystal On technique (hereinafter simply referred to as “LC On”) to efficiently prevent the brightness detection result obtained by the light sensor from being influenced by ambient light, and promoting the accuracy of color compensation.

For achieving these purposes, the present invention provides a liquid crystal display with function of static color compensation, comprising: a liquid crystal panel, a backlight source disposed on at least a side of the liquid crystal panel; at least a light sensing element disposed near to the liquid crystal panel, wherein the light sensing element comprising a light-sensitive surface oriented to the backlight source; and a timing controller which is used to control the performance of liquid crystal panel, receive the brightness value detected by the light sensing element as the liquid crystal off and compute to adjust the brightness of the backlight source accordingly. The liquid crystal display further comprises a source driver and a gate driver used for receiving signal of the timing controller to control liquid crystal module in liquid crystal panel. Furthermore, the timing controller comprises a color controller, and the color controller further comprises a register, a decay ambient light unit, a backlight data register, an ambient light data register, a color compensating unit and a color signal adjuster unit. The register further includes a liquid crystal off (LC Off) and backlight off (BL Off) sub-register, a liquid crystal off (LC Off) and backlight on (BL On) sub-register, a liquid crystal on (LC On) and backlight off (BL Off) sub-register and a liquid crystal on (LC On) and backlight on (BL On) sub-register which are used for respectively storing the brightness value detected by light sensing element in different situation.

In addition, the present invention provides a method for static color compensation in liquid crystal display, which comprises: turning off a liquid crystal and turning off a backlight source; detecting the brightness by a light sensing element to obtain a first value; turning off the liquid crystal and turning on the backlight source; detecting the brightness by a light sensing element to obtain a second value; computing the first value and the second value to obtain a brightness value of the backlight source; color compensating the brightness value of backlight source; and adjusting the brightness value for the purpose of correctly showing color image in liquid crystal display. Moreover, a liquid crystal display with function of static color compensation of the present invention is able to be applied in an electronic device. It comprises a main body and the liquid crystal display of the present invention is configured within the main body. In some embodiments of the present invention, the electronic device includes a notebook computer, and the light sensing element is configured at an appropriate position of keypad of the notebook computer, and detecting the brightness value of the backlight to perform the color compensation in the liquid crystal display as a cover of the notebook computer closing up. That is to say, the LC Off state of liquid crystal panel includes power off of the notebook computer, the notebook computer in idle mode, and a black frame state as the notebook computer restart. Additionally, the notebook computer further comprises a color compensation mode control button, which is used for control to perform static color compensation in liquid crystal display at any time.

One advantage of the present invention is effectively eliminating the influence the light sensing element caused by ambient light and accurately detecting the brightness of backlight source, and performing color compensation computation to adjust the brightness of backlight source according to the accurately detected brightness. It resulted in increasing the accuracy of color quality of image in liquid crystal display. Throughout the following embodiments, illustrated figures and claims of the present invention, the reader may more fully understand the present invention.

### BRIEF DESCRIPTION OF THE DRAWINGS

The invention is more fully appreciated in connection with the following detailed description taken in conjunction with the accompanying drawings; however, those skilled in the art will appreciate that these examples are not intended to limit the scope of the present invention, and various changes and modifications are possible within the sprit and scope of the present invention.

FIG. 1 is a flow diagram illustrating prior art method for detecting ambient light source and backlight source to perform color compensation.

FIG. 2 illustrates a non-uniform image shown on a liquid crystal display.

FIG. 3 is a system schematic block diagram illustrates a liquid crystal display with function of static color compensation of the present invention.

FIG. 4 is a flow diagram illustrating a method for color compensation applied on a liquid crystal display of the present invention.

FIG. 5 illustrates the location where a light sensing element configured on the liquid crystal panel.

FIG. 6A illustrates that a light sensing element is configured on the central location A of the liquid crystal panel.

FIG. 6B is a schematic diagram illustrating brightness value detected by the light sensing element configured on the central location A of the liquid crystal panel according to FIG. 6A.

FIG. 7A illustrates that the light sensing elements are respectively configured on the locations A and B of the liquid crystal panel.

FIG. 7B illustrates that the light sensing elements are respectively configured on the locations C to F of the liquid crystal panel.

FIG. 7C is a schematic diagram illustrating brightness values detected by the light sensing elements configured on the locations A to F of the liquid crystal panel.

FIG. 8 illustrates the light sensing element configured on an electronic device with the liquid crystal display.

FIG. 9 illustrates that an electronic device with the liquid crystal display has a color compensation function.

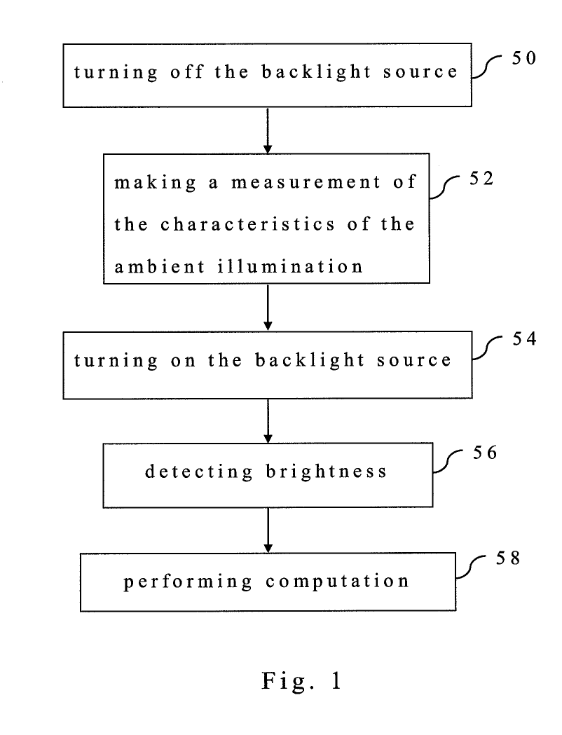

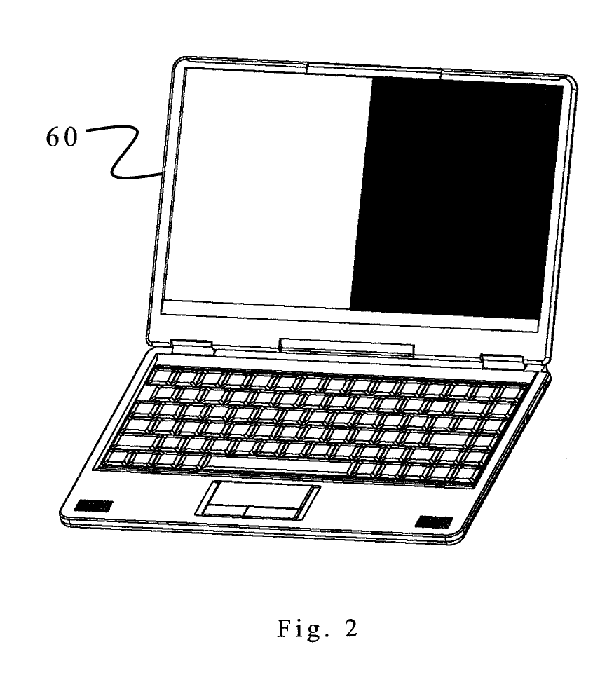

### DETAILED DESCRIPTION

In the description below, for the purposes of explanation, numerous specific details are set forth in order to provide a thorough understanding of the structure and process of the present invention. The scope of the present invention is expressly not limited but expected as specified in the accompanying claims. Therefore, the present invention can be widely applied to other embodiments.

The following examples describe the detail of the present invention. Please referring to the figures and description as follow, the same number in each figure indicates the identical item. It will be apparent, however, to one skilled in the art that the present invention may be practiced without some of these specific details. In addition, the figures may not illustrate each feature described in the embodiment and the elements shown in figures are not drawn to proportional scale.

The present invention discloses a method for static color compensation of a liquid crystal display, wherein the static color compensation is achieved by means of black frame technique and light sensing technique. The black frame technique is Liquid Crystal Off technique (hereinafter simply referred to as “LC Off”), which utilizes the liquid crystal molecules to be aligned horizontally for the purpose of producing a black frame. It also effectively prevents the ambient light source from influencing the accuracy of detecting backlight source and ambient light source of the light sensing elements through liquid crystal panel. The static color compensation stated here means performing color detection and compensation as no image on liquid crystal display. That is to say, the method for color compensation of a liquid crystal display of the present invention is performed when the liquid crystal display device display with a black frame. Take a liquid crystal display of computer as an example, the color compensation of the present invention can be performed when a black frame displayed in the computer booting up, or a black frame displayed in idle mode. Hence, the method for color detection and compensation of the present invention can be performed to adjust the backlight of liquid crystal display when the computer is in idle mode. In addition, a black frame may also be displayed as the computer restart, so that the method for color detection and compensation of the present invention can be performed to adjust the backlight of liquid crystal display when the computer restarts. It is effectively improving the quality of image displayed in the liquid crystal display. Furthermore, the present invention differs from the prior arts which the light-sensitive surface is opposite-oriented to the backlight source and oriented outward to detect the ambient light source. In the present invention, the light-sensitive surface of the light sensing element is oriented to the backlight source, and such a character effectively prevents the ambient light from influencing the accuracy of detecting backlight source and ambient light source of the light sensing elements through liquid crystal panel so that the light sensing element is able to detect whole brightness of backlight source more accurately. The higher image quality of liquid crystal display can be obtained by performing color compensation and adjusting the brightness of the backlight source according to the detected value.

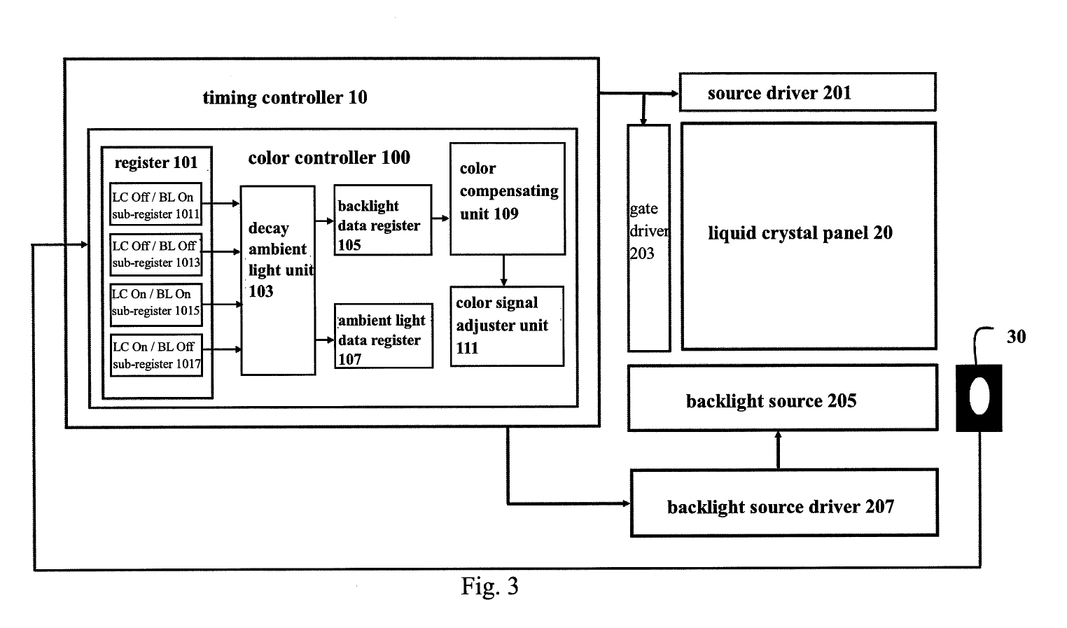

The liquid crystal display system which function color compensation of the present invention is introduced as follow. Please referring to FIG. 3, it is a system schematic block diagram illustrates a liquid crystal display with function of static color compensation of the present invention. The liquid crystal display system comprises a timing controller 10, a source driver 201, a gate driver 203, a liquid crystal panel 20, a backlight source 205 and a backlight source driver 207. The timing controller 10 is coupled to the source driver 201, the gate driver 203 and the backlight source driver 207, and used for receiving signals transmitted from the timing controller 10. The source driver 201 and the gate driver 203 are respectively disposed at two sides of the liquid crystal panel 20 and respectively connected to data lines, scan lines and pixels of the liquid crystal panel 20. As one row of scan line enabled by the gate driver 203 output pulse, the source driver 201 transfers the corresponding display data to voltage, and charges and discharges pixels of liquid crystal panel 20 to corresponding grey level voltage to present images. In addition, timing controller 10 may transmits signal to backlight source driver 207 to control the brightness of backlight source 205 and present images in liquid crystal panel 20. The light sensing element 30 is configured around the liquid crystal panel 20 and used to detect the brightness of the backlight source 205 and the ambient light source. The detected brightness value is then transmitted to the timing controller 10, and the signal data which is transmitted to the backlight source driver 207 is modified according to the detected brightness value. In one embodiment of the present invention, the timing controller 10 includes a color controller 100 which is connected to the backlight source driver 207. By means of the color controller 100, the color signal data is transmitted to the backlight source driver 207 to change the brightness emitted from the backlight source 205. Moreover, the color controller 100 further includes a register 101, a decay ambient light unit 103, a backlight data register 105, an ambient light data register 107, a color compensating unit 109 and a color signal adjuster unit 111. The register 101 is coupled to the light sensing element 30 and used for temporarily storing the brightness value detected by light sensing element 30. The decay ambient light unit 103 is coupled to the register 101 and used for read the brightness value temporarily stored in the register 101 and compute the brightness of the backlight source 205 and ambient light source accordingly. The brightness values of the backlight source 205 and ambient light source calculated by the decay ambient light unit 103 are respectively stored the backlight data register 105 and ambient light data register 107 temporarily which the backlight data register 105 and ambient light data register 107 are coupled to the decay ambient light unit 103. The backlight data register 105 is coupled to the color compensating unit 109, and the color compensating unit 109 is used to read the brightness value of the backlight source 205 stored in the backlight data register 105, and compute and transmit the color compensation value to the color signal adjuster unit 111. The color signal adjuster unit 111 which is coupled to the backlight source driver 207 is used to receive the color compensation value transmitted from the color compensating unit 109, transfer the value to signal needed for the backlight source driver 207 and transmit the signal to the backlight source driver 207. The backlight source driver 207 adjusts the brightness of the backlight source 205 accordingly. In the invention herein, the register 101 further comprises a liquid crystal off and backlight on (LC Off/BL On) sub-register 1011, a liquid crystal off and backlight off (LC Off/BL Off) sub-register 1013, a liquid crystal on and backlight on (LC On/BL On) sub-register 1015 and a liquid crystal on and backlight off (LC On/BL Off) sub-register 1017. The LC Off/BL On sub-register 1011 is used for temporarily storing the brightness value detected by light sensing element 30 in LC Off and BL On state; the LC Off/BL Off sub-register 1013 is used for temporarily storing the brightness value detected by light sensing element 30 in LC Off and BL Off state. The LC On/BL On sub-register 1015 is used for temporarily storing the brightness value detected by light sensing element 30 in LC On and BL On state; the LC On/BL Off sub-register 1017 is used for temporarily storing the brightness value detected by light sensing element 30 in LC On and BL Off state.

Next, it illustrates the performance of the system of the present invention. In the present invention, timing controller 10 transmits signal data to source driver 201 and gate driver 203 to control the voltage of thin film transistor in liquid crystal panel 20. At same time, the color controller 100 in the timing controller 10 transmits color signal to the backlight source driver 207 to control the backlight source 205. Then, using light sensing element 30 to perform detection and transfer the detected brightness value to the register 101 in the color controller 100 of the timing controller 10 for temporarily storing. According to different detecting conditions, the detected brightness values are respectively stored in different sub-registers. In the present invention, the detecting conditions of the light sensing element 30 include LC Off/BL On, LC Off/BL Off, LC On/BL On and LC On/BL Off. The detected brightness values in different conditions are respectively stored in the LC Off/BL On sub-register 1011, the LC Off/BL Off sub-register 1013, the LC On/BL On sub-register 1015 and the LC On/BL Off sub-register 1017.

And then, the brightness values temporarily stored in the LC Off/BL On sub-register 1011, the LC Off/BL Off sub-register 1013, the LC On/BL On sub-register 1015 and the LC On/BL Off sub-register 1017 would transmit to the decay ambient light unit 103 to perform computation to separate the brightness value of ambient light source and the brightness value of backlight source 205. The computed brightness value of backlight source 205 is temporarily stored in the backlight data register 105, and the computed brightness value of ambient light source is temporarily stored in the ambient light data register 107. As a result, the computed brightness value of backlight source 205 is effectively subtracted from influencing of brightness of the ambient light source. The computed brightness value of the backlight source 205 stored in the backlight data register 105 is transmitted to the color compensating unit 109 to perform color compensation, and the accurate color compensation value of the backlight source 205 can be obtained. The color compensation value is transmitted to the color signal adjuster unit 111 to be transferred to input signal needed for the backlight source driver 207, such as Pulse Width Modulation (PWM), voltage or current. By the color signal adjuster unit 111, the computed color signal is transmitted to the backlight source driver 207 for the purpose of adjusting the brightness of the backlight source 205.

In some embodiments of the present invention, the liquid crystal display is a color sequential display, the backlight source 205 is a RGB LED, and the backlight source driver 207 controls three primary color (RGB) to yield the desired color according to the color signal received by timing controller 10. The color signal adjuster unit 111 comprises a reference table for inputting the backlight source driver 207, for example, RGB pulse width modulation, voltage and current.

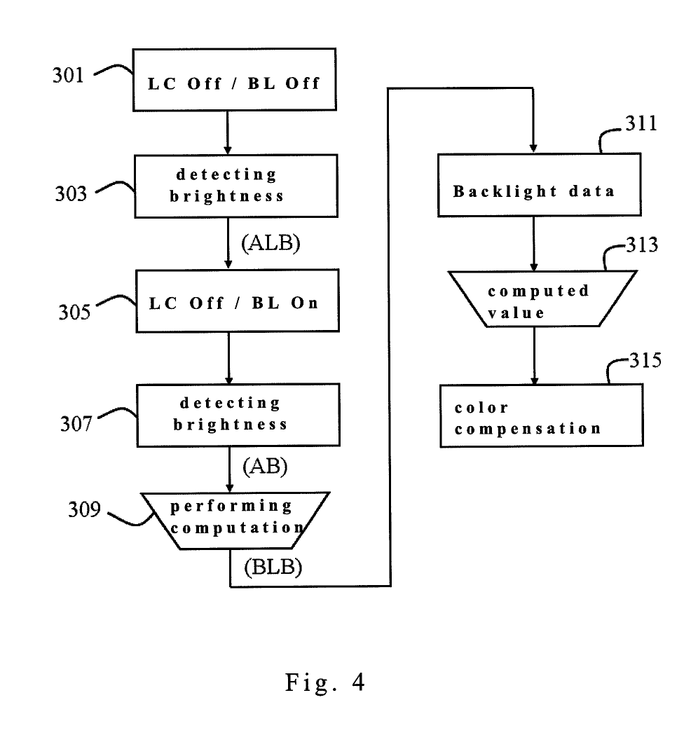

After illustrating the system frame of the present invention, please referring FIG. 4, it is a flow diagram illustrating a method for color compensation applied on a liquid crystal display of the present invention. The system frame shown in FIG. 3 is illustrated in detail as follow:

First, in step 301 and step 303, perform the process of LC Off/BL Off and then detect the brightness. In the embodiment, the state of LC Off/BL Off is a black frame displayed on the liquid crystal panel 20 of the liquid crystal display. The purpose of displaying a black frame on liquid crystal panel 20 is preventing the ambient light from transmitting through the liquid crystal panel 20. In step 301, the purpose of turning off the backlight source 205 is utilizing the light sensing element 30 to detect the transmission state of ambient light through the liquid crystal panel 20 in LC Off state. And the detected brightness value in step 303 is ambient light brightness (ALB). In the embodiment, the detected brightness value is temporarily stored in the LC Off/BL Off sub-register 1013 of the color controller 100 in timing controller 10.

And then, in steps 305 and 307, perform LC Off/BL On process and detect the brightness. In the embodiment, in state of turning off the liquid crystal and turning on the backlight source 205, the panel of display device still displays a black frame. In this moment, the detected brightness value is the sum of the brightness of the backlight source 205 and the brightness of ambient light which transmits through the liquid crystal panel 20 in LC Off state. Said detected brightness value is all brightness (AB). Equally, in the embodiment, the detected brightness value is temporarily stored in the LC Off/BL On sub-register 1011 of the color controller 100 in timing controller 10.

After steps 301 to 307, perform computation in step 309. In the embodiment, the computation is for obtaining the brightness of backlight (backlight brightness, BLB), wherein the computation is according to the equation as follow: BLB=AB-ALB. As a result, the backlight data 311 is obtained.

As the backlight data 311 obtained, the brightness value of backlight source 205 of liquid crystal display is also computed. In step 309, the influence to the light sensing element 30 by ambient light is eliminated, such that the backlight data 311 is the brightness emitted from the backlight source 205 of liquid crystal display. According to the backlight data 311 to perform computation, the computed value 313 is used for accomplishing color compensation 315 in liquid crystal display and improving the image quality of liquid crystal display.

In some embodiments, in order to get more accurate brightness value of backlight source 205, it may additionally perform detection in LC On/BL On and LC On/BL Off state. Such detected results enable the brightness value of the backlight source 205 is more accurate, and the result of computation in the color compensating unit 109 is more precise, and the color quality of the liquid crystal panel 20 is more accurate.

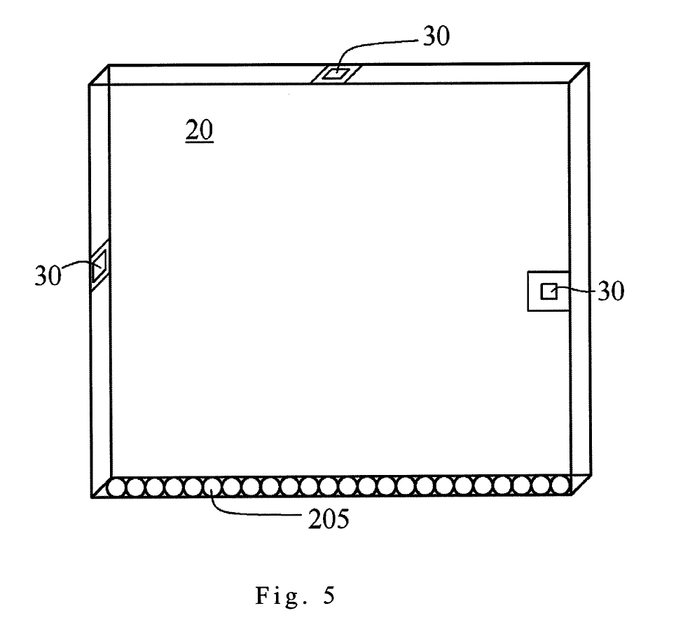

In the embodiment, the light sensing elements 30 are disposed around the liquid crystal panel 20. Please referring to FIG. 5, the backlight source 205 is disposed on one side of liquid crystal panel 20 and the light sensing elements 30 can be disposed, but not limited, on other three side of liquid crystal panel 20 for brightness detection. Additionally, in the embodiment, the light-sensitive surface of each light sensing element 30 is oriented to the backlight source 205 to detect the brightness of the backlight source 205. Although there are three light sensing elements 30 shown in FIG. 5, those skilled in the art will appreciate that the invention is not limited to the number of light sensing elements. In some embodiments of the present invention, the static color compensation of the present invention can also be accomplished by means of one light sensing element 30.

For more clearly illustrating the advantages of the present invention, the results of experiments are disclosed as follow:

1. Difference between LC Off and LC On:

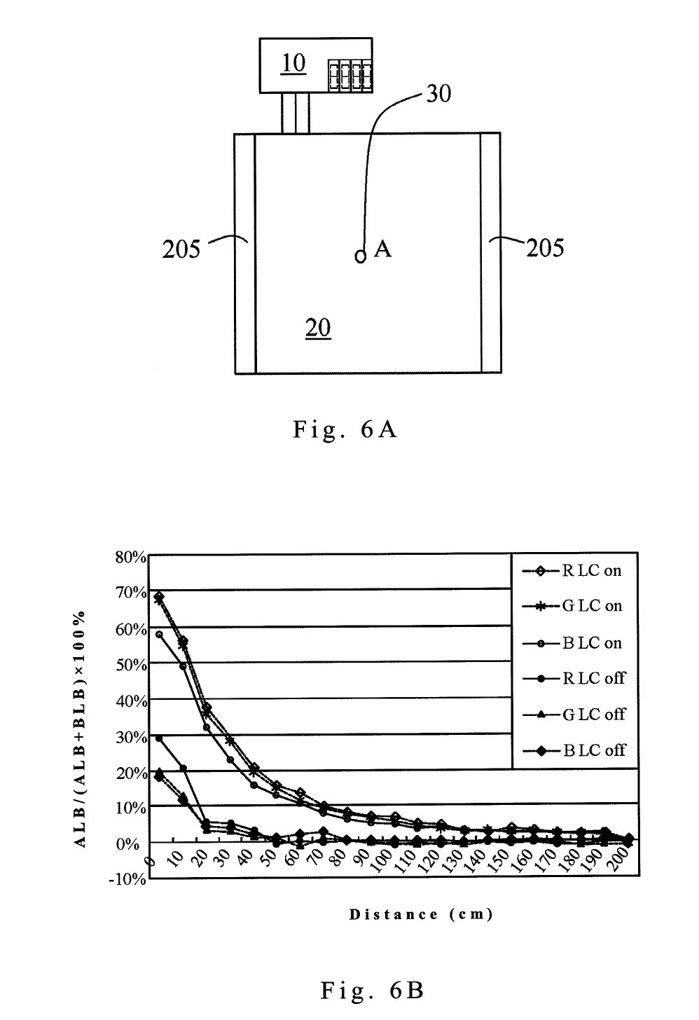

Please referring to FIG. 6A and FIG. 6B, wherein FIG. 6A illustrates that a light sensing element 30 is configured on the central location A of the liquid crystal panel 20, and FIG. 6B illustrates brightness value detected by the light sensing element 30 configured on the central location A of the liquid crystal panel 20 according to FIG. 6A.

In the embodiment, the backlight sources 205 are disposed on both sides of the liquid crystal panel 20, and the timing controller 10 is connected to the liquid crystal panel 20 and backlight sources 205 for controlling the liquid crystal panel 20 and backlight sources 205. The light sensing element 30 is configured on the central location A of the liquid crystal panel to detect brightness. In the embodiment, the backlight sources 205 are RGB LEDs which are able to emit red light, green light and blue light respectively.

FIG. 6B shows the result of experiments, wherein the brightness is detected respectively against three primary colors (RGB) in LC On and LC Off state. In FIG. 6B, the horizontal coordinate axis represents the distance between light sensing element 30 and the backlight source 205. As the FIG. 6B shown, the longer distance resulted in lower detected brightness value. The vertical coordinate axis represents the percentage of the detected ambient light brightness (ALB) divided by ambient light brightness plus backlight source brightness (ALB+BLB) value, the equation shown as follow: ALB/(ALB+BLB)×100%. In addition, FIG. 6B shows six experimental results, which includes detection result of the red light in LC On state, detection result of the green light in LC On state, detection result of the blue light in LC On state, detection result of the red light in LC Off state, detection result of the green light in LC Off state and detection result of the blued light in LC Off state.

As shown in FIG. 6B, in LC On/BL On state, the average brightness value of three primary colors detected by the light sensing element 30 is about 60%. In LC Off/BL On state, the average brightness value detected by the light sensing element 30 is about 30%. The experimental results have demonstrated the more efficacies of preventing transmittance of ambient light and reducing the influence to detection of the light sensing element 30 in LC Off state than in LC On state.

2. The location of the light sensing element:

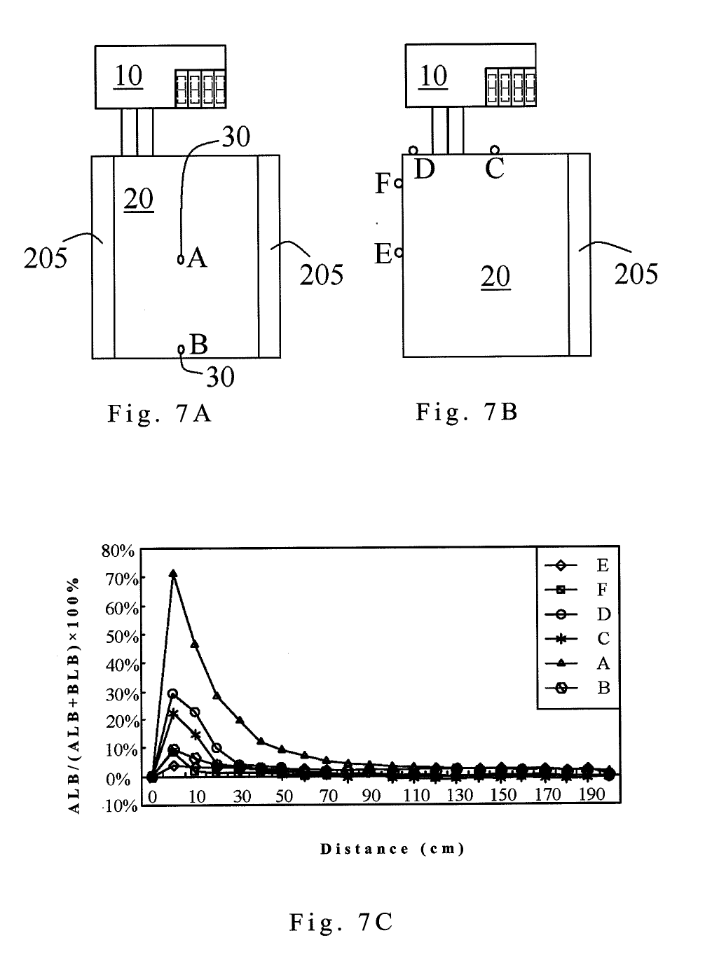

Please referring to FIG. 7A, it illustrates that two backlight sources 205 are respectively disposed on the both sides of the liquid crystal panel 20, and a light sensing element 30 is disposed on the central location A of the liquid crystal panel 20 and the other light sensing element 30 is disposed on the lateral location B of the liquid crystal panel 20. Next, please referring to FIG. 7B, it illustrates that the liquid crystal panel 20 comprises one backlight source 205; two light sensing elements 30 which are disposed on the location C and D by the side of the backlight source 205; another two light sensing elements 30 are disposed on location E and F opposite to the backlight source 205. Perform the brightness detection by means of the light sensing elements 30 disposed on location A to F. Please referring to FIG. 7C, it illustrates the brightness values detected by the light sensing elements 30 disposed on the locations A to F of the liquid crystal panel 20 in LC Off/BL On state. The horizontal coordinate axis represents the distance between each light sensing element 30 and the backlight source 205, and the vertical coordinate axis represents the percentage of the detected ambient light brightness (ALB) divided by ambient light brightness plus backlight source brightness (ALB+BLB) value, the equation shown as follow:

ALB/(ALB+BLB)×100%.

As shown in FIG. 7C, the average brightness value detected by the light sensing element 30 disposed on the location A to D of the liquid crystal panel 20 is about 15%, and the average brightness value detected by the light sensing element 30 disposed on the location E to F of the liquid crystal panel 20 is about 1.37%. Consequently, as FIG. 7C shown, the best location to dispose the light sensing element 30 is the opposite site of the backlight source 205 (i.e. locations E and F). In FIG. 7C, it has clearly demonstrated that more than 98.63% ambient light is effectively prevented in LC Off state when the light sensing element 30 is disposed on the opposite site of the backlight source 205.

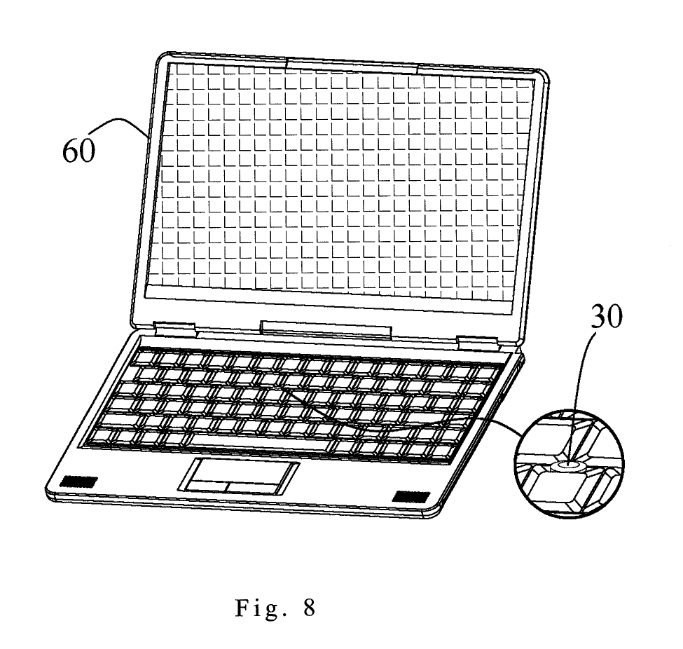

Furthermore, in some embodiments, the light sensing element is unnecessary to be configured on liquid crystal panel. It can be configured on the main body of the electronic device with the liquid crystal panel. Please referring to FIG. 8, it illustrates a notebook computer 60 with a light sensing element 30. Although in the embodiment, it takes a notebook computer 60 as an example, those skilled in the art will appreciate that the invention is not limited to apply in notebook computer. The present invention is able to widely apply in any electronic device with a liquid crystal display. In FIG. 8, the light sensing element 30 is disposed at an appropriate position of keypad of the notebook computer 60 and the light-sensitive surface is oriented upward. As a result, in LC On/BL On state, the light sensing element 30 is able to detect the brightness of the backlight source through the liquid crystal panel as a cover of the notebook computer 60 closing up. Because of the cover of the notebook computer 60 closing up, it can be ensured that light sensing element 30 is not influenced by ambient light source as detecting the brightness of the backlight source. The detected brightness value of the backlight source is the brightness value of backlight which has been transmitted through the liquid crystal panel. That is to say, the detection considers the transmittance of the backlight through the liquid crystal panel, and the according color correction is more suitable for human visual perception.

In addition, the present invention may use the black frame (LC Off) state achieved by the electronic device with liquid crystal display itself. In another embodiment of the present invention, it may configure a color compensation mode, such as a functional button installed in the electronic device, for a user to manually set the black frame (LC Off) state and synchronously perform the detection of the brightness of backlight source and color compensation when the user would like to perform color adjustment in the liquid crystal display device.

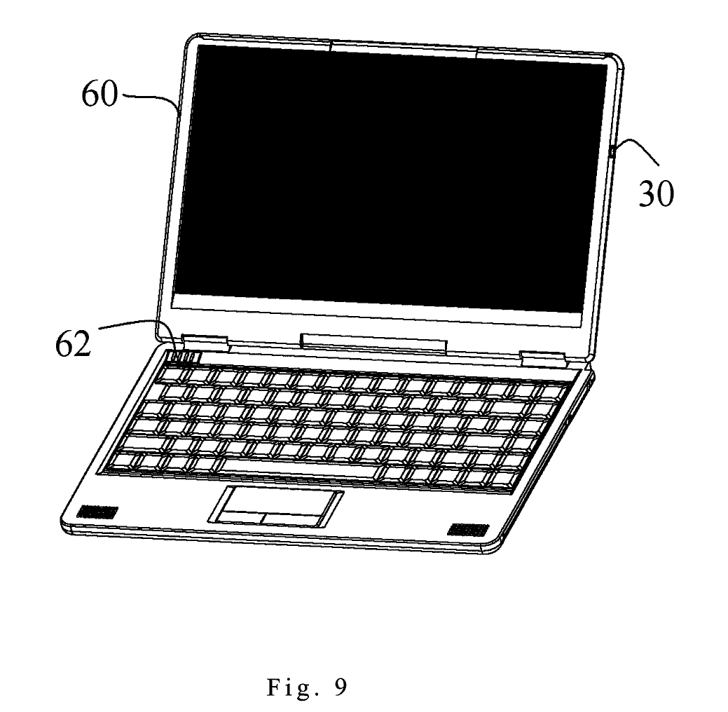

Please referring to FIG. 9, it illustrates that a notebook computer 60 which a light sensing element 30 is disposed around the liquid crystal panel of the notebook computer 60, and a control button 62 for color compensation is installed in the notebook computer 60. As a result, when a user would like to adjust color representation on the liquid crystal display, the user can manually set the black frame (LC Off) state on the liquid crystal display by the control button 62 and perform the color detection and compensation of the present invention. Although in the embodiment, it takes a notebook computer 60 as an example, those skilled in the art will appreciate that the invention is not limited to apply in notebook computer. The present invention is able to widely apply in any electronic device with a liquid crystal display.

As above mentioned, the present invention utilizes LC Off technique and light sensing technique to detect the brightness of the backlight source and eliminate the influence of ambient light for the purpose of color compensation of the backlight source. By means of LC Off technique, the influence to the light sensing element by ambient light is largely eliminated, and more accurate brightness value of backlight source is obtained by the static color compensation of the present invention. It promotes the accuracy of color compensation of backlight source and enables the liquid crystal display with function of static color compensation of the present invention to provide more accurate quality color image.

The above descriptions are the preferred embodiments of the present invention. Those skilled in the art readily will appreciate that the scope of the present invention is not limited to the described preferred embodiments. The scope of the present invention is expressly not limited expect as specified in the accompanying claims. Various changes and modifications can be made within the spirit and scope of the present invention, as defined by the following Claims.

What is claimed is:

1. A liquid crystal display with function of static color compensation, comprising:
a liquid crystal panel;
a backlight source disposed on at least a side of the liquid crystal panel;
at least a light sensing element disposed near to the liquid crystal panel, wherein the light sensing element comprising a light-sensitive surface oriented to the backlight source; and
a timing controller which is used to control the performance of the liquid crystal panel, receive brightness values detected by the light sensing element as the liquid crystal off and perform computation to adjust the brightness of the backlight source accordingly.

2. A liquid crystal display according to claim 1, wherein the liquid crystal display comprises a color sequential display.

3. A liquid crystal display according to claim 2, wherein the backlight source is a three primary colors (RGB) Light emitting diode (LED).

4. A liquid crystal display according to claim 1, further comprising a source driver and a gate driver used for receiving signal from the timing controller to control liquid crystal modules.

5. A liquid crystal display according to claim 1, wherein the timing controller further comprises a color controller.

6. A liquid crystal display according to claim 5, wherein the color controller further comprises a register, a decay ambient light unit, a backlight data register, an ambient light data register, a color compensating unit and a color signal adjuster unit.

7. A liquid crystal display according to claim 6, wherein the register further comprises a liquid crystal off (LC Off) and backlight off (BL Off) sub-register, a liquid crystal off (LC Off) and backlight on (BL On) sub-register, a liquid crystal on (LC On) and backlight off (BL Off) sub-register and a liquid crystal on (LC On) and backlight on (BL On) sub-register which are used for respectively storing the brightness value detected by the light sensing element in different condition temporarily.

8. A liquid crystal display according to claim 6, wherein the decay ambient light unit is used to compute the brightness values of the backlight source and the brightness values of ambient light source according to the brightness values temporarily stored in the registers.

9. A liquid crystal display according to claim 8, wherein the backlight data register is used to temporarily store the brightness values of the backlight source, and the ambient light data register is used to temporarily store the brightness values of the ambient light.

10. A liquid crystal display according to claim 9, wherein the color compensating unit is used to receive the brightness values of the backlight source and perform computation of color compensation and transmit the computed results to the color signal adjuster unit for adjustment of backlight brightness.

11. A liquid crystal display according to claim 1, further comprising a backlight source driver which is used for receiving signals transmitted from the timing controller to drive the backlight.

12. A liquid crystal display according to claim 1, wherein the light sensing element is disposed on opposite side of the backlight source.

13. A liquid crystal display according to claim 1, wherein the liquid crystal display is applied in an electronic device, wherein the electronic device further comprises a main body and the liquid crystal display is configured in the main body.

14. A liquid crystal display according to claim 13, wherein the electronic device is a notebook computer.

15. A liquid crystal display according to claim 14, further comprising another light sensing element disposed at an appropriate position of keypad of the notebook computer, wherein the another light sensing element performs brightness detection and color compensation as a cover of the notebook computer closing up.

16. A liquid crystal display according to claim 14, wherein the liquid crystal off state comprises the notebook computer booting up, the notebook computer in idle mode, or a black frame state as the notebook computer restart.

17. A liquid crystal display according to claim 13, further comprising a control button used for manually performing the color detection and compensation of the liquid crystal display.

18. A method for performing static color detection and compensation of a liquid crystal display device, comprising:
turning off a liquid crystal and turning off a backlight source;
using a light sensing element to detect brightness to obtain a first value;
turning off the liquid crystal and turning on the backlight source;
using the light sensing element to detect brightness to obtain a second value;
computing the first value and the second value to obtain a brightness value of the backlight source; and
performing computation of color compensation according to the brightness value of the backlight source to adjust the brightness of the backlight source and enable the liquid crystal display device to have accurate display quality.

19. A method for performing static color detection and compensation of a liquid crystal display device according to claim 18, wherein turning off the liquid crystal comprises the liquid crystal display device displaying a black frame.

20. A method for performing static color detection and compensation of a liquid crystal display device according to claim 18, wherein the first value is the brightness of ambient light which transmits through a panel of the liquid crystal display device in liquid crystal off state.

21. A method for performing static color detection and compensation of a liquid crystal display device according to claim 18, wherein the second value is an all brightness value which is the sum of the brightness value of ambient light which transmits through the panel and the brightness of backlight source.

22. A method for performing static color detection and compensation of a liquid crystal display device according to claim 18, wherein the liquid crystal display device comprises a color sequential display.

23. A method for performing static color detection and compensation of a liquid crystal display device according to claim 22, wherein the backlight source is a three primary colors (RGB) Light emitting diode (LED).
